(19) United States
(12) Patent Application Publication
(10) Pub. No.: US 2020/0286394 A1
(43) Pub. Date: Sep. 10, 2020

(54) METHOD AND SYSTEM FOR ENHANCED 3D AWARENESS OF THE ENVIRONMENT LINKED TO THE GROUND AROUND AN AIRCRAFT AND ANTICIPATION OF THE POTENTIAL ENVIRONMENTAL THREATS

(71) Applicant: THALES, COURBEVOIE (FR)

(72) Inventors: Xavier RUEFF, TOULOUSE (FR); Thierry GANILLE, Mérignac (FR); Betty BASTAREAUD, TOULOUSE (FR); Ronan DEMOMENT, TOULOUSE (FR)

(21) Appl. No.: 16/796,884

(22) Filed: Feb. 20, 2020

(30) Foreign Application Priority Data
Mar. 7, 2019 (FR) 1902310

(51) Int. Cl. G08G 5/04; G08G 5/00; G01C 23/00; G05D 1/04; B64D 45/04; B64C 27/02

(52) U.S. Cl. CPC G08G 5/045; G08G 5/0086; G08G 5/0021; B64C 27/02; G01C 23/005; G05D 1/044; B64D 45/04; G08G 5/0013

(57) ABSTRACT

A method for enhanced three-dimensional awareness of the environment linked to the ground around an aircraft and anticipation of the potential threats of the environment is implemented by a system for enhanced 3D awareness of the environment around the aircraft comprising an electronic enhanced three-dimensional environment awareness and piloting assistance computer, an obstruction database, and a primary flight display PFD, included in a synthetic vision system SVS or derivative. The method for enhanced three-dimensional awareness of the environment and anticipation of potential environmental threats comprising: a first step of calculation of a panoramic curve of safe minimum slope as a function of the azimuth angle of vision from the aircraft in a local horizontal plane; and a second step, consecutive and executed on command, of display of the panoramic curve of safe minimum slope and of any piloting assistance information.

### CROSS-REFERENCE TO RELATED APPLICATIONS

This application claims priority to foreign French patent application No. FR 1902310, filed on Mar. 7, 2019, the disclosure of which is incorporated by reference in its entirety.

### FIELD OF THE INVENTION

The present invention relates to an avionics method and an avionics system for enhanced three-dimensional awareness of the environment linked to the ground around an aircraft and anticipation of the potential threats of said environment, options for escaping from said threats being able to be proposed using a conformal display, by merging a three-dimensional perspective representation of the terrain around the aircraft and synthetic aircraft piloting assistance information, consistent with the flight path vector of said aircraft.

The present invention relates in particular to a method and a system for conformal three-dimensional display of the terrain and of synthetic aircraft piloting assistance information, consistent with the flight path vector of said aircraft, and configured to spatially enhance the conventional three-dimensional field of view of the potential terrain threats around the aircraft and, temporally, the diversity of the piloting options for escaping from said threats.

The technical field of the invention encompasses that of the terrain awareness and collision warning methods and systems TAWS (“Terrain Awareness and Warning System”) and of the display systems such as a Synthetic Vision System SVS, an enhanced vision system EVS, a Combining Vision System CVS, and/or conformal vision displays, Head-Up Display (HUD) or Head-Worn Display (HWD), the requirement for a flight path vector having to be satisfied.

### BACKGROUND

When an aircraft flies close to a threat coming from the ground, the pilot or the crew needs to understand the configuration or the state of the environment, and, in the case of a protection warning with respect to a terrain threat, for example a collision with the ground, the pilot must take rapid and precise decisions concerning the escape manoeuvres that the aircraft must perform to avoid the threats without exceeding its capabilities in performing such manoeuvres.

In the case of terrain warnings, the current protection systems TAWS, and more particularly the HTAWS (Helicopter TAWS) systems dedicated to helicopters, provide an assistance to the pilot through two display means:

a display of a two-dimensional 2D representation representing the terrain threats according to a first means,

a display of a conformal three-dimensional 3D representation of the terrain threats according to a second means which uses a synthetic vision system (SVS) or a vision system derived from an SVS.

A display of a two-dimensional 2D view of the terrain threats was introduced into the line aeroplanes in the 1990s through the TAWS function to satisfy the requirement for a display of a two-dimensional 2D view of the surrounding terrain at the altitudes close to that of the aircraft, for triggering and displaying a warning for a threatening terrain.

This type of display is well suited to aircraft which do not fly in proximity to the ground apart from in the take-off and landing phases, given that it primarily provides the information necessary to execute vertical escape manoeuvres.

However, one drawback with the display of a two-dimensional 2D view described above is notably the fact that, when the aircraft flies along a canyon or a valley below the mountain altitude, all the mountain peaks appear with the second visual potential threat indicator (for example the colour red), no indication being consequently provided regarding the actual capacity of the aircraft to manoeuvre above the mountain peaks.

The Patent Application WO 2016/193975 A1, constituting a first document, describes in detail an enhanced system and method for calculating and displaying a two-dimensional 2D view of the potential terrain threats which resolves the abovementioned drawback by taking into account both data concerning the real-time kinematics of the aircraft and aircraft performance data, also designated as “performance or flight envelope” data, concerning the climb capacity of the aircraft as a function, notably, of the elevation, the temperature, the weight and the horizontal speed.

The first document describes an avionics method and an avionics system for calculation and display of terrain awareness around an aircraft and of potential threats of collision with the ground, configured to:

calculate, at a current instant and from a current position of the trajectory of an aircraft, for each point of a part of a terrain around the aircraft at said current instant, whether the aircraft can or cannot manoeuvre above said terrain point with a safe gap or clearance, set by a predetermined safety margin, and provide a map or a chart of correlation between the projections of the points in the part of terrain in the lateral plane of the trajectory and the Boolean expressing the capacity or the incapacity of the aircraft to overfly said points safely; and

display the calculated two-dimensional 2D map by matching the lateral projection of each point of the terrain part with a first visual indicator (for example the colour yellow when the aircraft is capable of safely overflying said point or a second, different visual indicator (for example the colour red), distinct from the first visual indicator, when the aircraft is not capable of safely overflying said point.

However, the avionics method and system of the first document present the drawback of not providing accurate information regarding the slope of climb of the escape trajectories if only for a single one of them, of not providing a nuanced criterion of the performance demanded of the aircraft as a function of the escape trajectory, and of not providing a conformal three-dimensional 3D vision of the environment of the aircraft, clearly and intuitively perceptible, in which the terrain hazard information items in their vertical dimension are more immediately and clearly perceptible.

The Patent Application EP 2 224 216 A1, constituting a second document, partially addresses the abovementioned drawbacks and describes a system and a method for calculating and displaying a three-dimensional 3D view of the terrain environment of an aircraft. The three-dimensional 3D view, displayed by the primary flight display PFD, is a conformal perspective synthetic view of the terrain around the aircraft in real time or virtually in real time. The terrain fills the screen of the primary flight display PFD. The primary flight display PFD is configured to include in the 3D view a terrain avoidance guiding item, displayed conformally relative to the terrain. This guiding item visually communicates to the pilot instructions, directives or preferences, for navigation and control, when a potentially threatening terrain is approaching. The pilot can thus rapidly and easily determine the best way to manoeuvre the aircraft in the vicinity of the part of terrain forming the obstruction. Preferably, the guiding item is coordinated intuitively with the symbol representing the real-time flight path vector, so that the pilot can visually determine where to direct the aircraft, and therefore its flight path vector, to switch off the terrain avoidance warning.

According to the second document, the terrain avoidance guiding item is displayed only when, at a current flight instant, a terrain collision threat has been detected by the terrain awareness and warning system TAWS and remains focused on the terrain threat within the limit of the field of view and of analysis of the TAWS. A single avoidance manoeuvre is suggested by the terrain avoidance guiding item and it concerns a local zone of the peak of the obstacle to be avoided with, essentially, a vertical escape component, the only component observed with precision.

Thus, the avionics method and system of the second document present the drawback of being limited spatially and temporally to the terrain threats and warnings triggered by the TAWS system and of neglecting the beneficial role of possible manoeuvres, with single lateral component or mixed lateral component combined with a vertical escape component, outside of the scope of directions analysed by the TAWS and possibly ranging up to a complete half-turn of the aircraft, and being able to be anticipated earlier to provide adequate and gentler escape piloting without overreaction.

In this respect, the pilots have expressed the need to have information enabling them to decide on the utility and the merit of a suitable lateral escape manoeuvre, possibly ranging up to performing a half-turn if necessary, and the requirement for a time for them to interpret said manoeuvre that is as short as possible, because urgent decisions may be necessary, the current systems and methods not making it possible to satisfy such requirements.

A first technical problem that the invention resolves is providing an avionics method and an avionics system for enhanced terrain awareness and anticipation of the potential terrain threats, using a 3D synthetic terrain vision system or derivative with a conformal flight path vector, in which the field of awareness of the terrain threats surrounding the aircraft and of the options for escaping from said threats is widened compared to the current terrain awareness and warning avionics systems.

A second technical problem that the invention resolves is enriching and refining, by an avionics method and an avionics system for enhanced terrain awareness and anticipation of the potential terrain threats, the spectrum of escape options on the lateral manoeuvre components up to having the aircraft perform half-turn manoeuvres.

A third technical problem that the invention resolves is providing an avionics method and an avionics system for enhanced terrain awareness and anticipation of the potential terrain threats which make it possible to avoid a piloting overreaction with respect to the terrain threats through a better anticipation of said threats and a wider spectrum of possible avoidance manoeuvres.

A fourth technical problem that the invention resolves is enhancing the content and the form of the display by enriching the terrain awareness on a primary flight and piloting display presenting a conformal flight path vector incorporated in a synthetic vision system SVS or derivative.

### SUMMARY OF THE INVENTION

To this end, the subject of the invention is a method for enhanced three-dimensional awareness of the environment linked to the ground around an aircraft and anticipation of the potential threats of said environment. The method for enhanced 3D awareness of the environment and anticipation of the potential environmental threats is implemented by a system for enhanced 3D awareness of the environment around the aircraft and of potential environmental threats comprising:

an electronic enhanced three-dimensional environment awareness and piloting assistance computer; and

an obstruction database configured to provide the electronic environment awareness computer with data modelling a set of obstruction objects likely to be environmental threats for the aircraft; and

a primary flight display PFD, included in a synthetic vision system SVS or derivative, and configured to conformally display, in the terrain representation, a flight path vector symbol. The method for enhanced three-dimensional awareness of the environment and anticipation of potential environmental threats comprises:

a first step of calculation of a panoramic curve of a safe minimum slope that is a function of the azimuth angle of vision from the aircraft in a local horizontal plane; and

a second step, consecutive and executed on command, of display of the panoramic curve of safe minimum slope and of any piloting assistance information.

According to particular embodiments, the method for enhanced 3D awareness of the environment linked to the ground and anticipation of the potential threats of said environment comprises one or more of the following features, taken alone or in combination:

the first, calculation step comprises: a first substep during which, at a current instant t, the position of a reference point O(t+Tr) and of a possible start t+Tr of avoidance manoeuvre is calculated by following the current trajectory of the aircraft starting from the current position O(t) of the aircraft at the instant t for a predetermined duration Tr which corresponds to a reaction or response time; a consecutive second substep during which, for each obstruction object of a set OB1(t) of obstruction objects, situated within a predetermined radius R in the lateral or horizontal vicinity of the aircraft relative to the point O(t+Tr) and outside of the lateral vicinity of the aircraft relative to the point O(t) within a reaction radius Rr, equal to the lateral distance between the points O(t) and O(t+Tr), with R significantly greater than Rr, a horizontal path or lateral flight component to reach the envelope of the obstruction object of the set OB1(t) of obstruction objects is calculated;

the predetermined duration Tr which corresponds to a reaction or response time typically lies between 0 and 2 seconds; and/or each lateral path is composed of a turn with a rate of turn standardized as a function of the type of the aircraft and of the manoeuvring capabilities of the aircraft, and/or of a successive rectilinear segment from the exit from the turn to the obstruction object;

the environmental threats linked to the ground for the aircraft concern the terrain threats including the geographic terrain and artificial obstacles and concern air space volumes that are prohibited because they can possibly be reached by projectiles launched from the ground;

the obstruction objects of the set OB1(t), processed in the second substep, are provided by the second database of the obstruction objects;

the first, calculation step comprises a third substep during which, for each obstruction object of the set OB1(t), a margin M is added to the elevation of the envelope point of said obstruction object and the slope between the point O(t+Tr) reached by following, after the current instant t, the trajectory of the aircraft for the predetermined duration Tr of reaction time and the point of overflight at the safe avoidance distance M from the envelope point of the obstruction object is calculated by considering the horizontal trajectory determined in the second substep; the first, calculation step comprises a fourth substep, executed after the third substep and during which the obstruction objects of the set OB1(t) are grouped together by azimuth direction of visibility from the aircraft in segments or sweeps of azimuth directions of the same width or angular resolution pitch n, the angular resolution pitch n being expressed for example in degrees;

the first, calculation step comprises a fifth substep, executed after the fourth substep and during which, for each sweep of azimuth directions scanning an azimuth field of view of the aircraft, the maximum of the safe minimum slopes of the obstruction objects contained in said sweep of azimuth directions is determined by the computer for enhanced 3D awareness of the terrain surrounding the aircraft, so that each sweep of azimuth directions has an associated point whose abscissa is the mean azimuth angle of the sweep along the current horizontal azimuth axis of the aircraft and the ordinate is the maximum value of the safe minimum slopes of the obstruction objects contained within the sweep, said maximum value being called “safe minimum slope of said sweep of azimuth directions”;

the panoramic curve of safe minimum slope which is a function of the azimuth direction, considered in the current horizontal plane of the aircraft, is a curve regularly interpolating the points calculated in the fifth substep, associated respectively with the sweeps of azimuth directions scanning the azimuth field of view of the aircraft;

the azimuth field of view of the aircraft scanned by the sweeps of azimuth directions is greater than the azimuth field of a conventional terrain awareness and warning subsystem, notably a system of TAWS type, preferably significantly greater, that is to say at least two times greater;

the first, calculation step comprises a sixth substep in which: for each azimuth direction, the position of the associated point of the panoramic curve of safe minimum slope is compared to the maximum slope that can effectively be achieved by the aircraft as set by the performance envelope of the aircraft; and, for each azimuth direction considered, the ratio of the ordinate of the associated point of the panoramic curve of safe minimum slope, i.e. the safe minimum slope, to the maximum slope that can be achieved by the aircraft is calculated then coded by a colour code or line pattern, representative of a level of ease with which the obstruction object can safely be overflown;

the first, calculation step comprises a seventh substep, executed after the sixth substep, and in which a condition or a criterion of display of the panoramic safe slope line is calculated by comparing the position of the panoramic curve of safe minimum slope to the position of the current flight path vector; and, if there is an azimuth direction for which the position difference between the flight path vector and the associated point of the panoramic curve of safe minimum slope becomes too low, that is to say if the ordinate in terms of pitch of the flight path vector minus the safe minimum slope of the corresponding point of the panoramic curve is less than or equal to a predetermined positive threshold value, a command to display the panoramic curve of safe minimum slope and any supporting information items is sent;

the second, display step is implemented when a display command is received by the primary flight display; and, during the second, display step, the primary flight display PFD displays, by merging them conformally, the panoramic curve of safe minimum slope and in support, a first graphic information item and/or a second graphic information item and/or, in support, a third graphic information item and/or, in support, a fourth graphic information item;

the display of the panoramic curve of safe minimum slope takes place conformally in the wide field of view of the primary flight display; and/or the first graphic item concerns the display for each sweep of azimuth direction of a calculated and coded ratio of the safe minimum slope to the maximum slope of climb that can be achieved by the aircraft, in the form of a colour or a corresponding line pattern according to a chosen coding of the calculated ratio; and/or the second graphic information item concerns the capacity to find a safe slope outside of the field of view of the primary flight display for azimuth directions which cannot be displayed in the field of view of the display; and it is formed by a bar, displayed on one side of the PFD screen, indicating the maximum possible turn with a safe turn attitude at the current speed; and/or the third graphic information item concerns a graphic item indicating the minimum roll angle necessary to perform a safe lateral escape, and, in case a warning is triggered, indicates the “prohibited” roll angles on a roll scale; and/or the fourth graphic information item concerns surveillance information correlated with the TAWS system or other warning systems, and it is displayed on or in immediate proximity to the panoramic curve of safe minimum slope so as to reveal the zone of operation of the TAWS warning system or of the other warning systems, by increasing the line thickness of the panoramic curve of safe minimum slope in said zone of the warning system or systems.

Another subject of the invention is a system for enhanced three-dimensional awareness of the environment linked to the ground around an aircraft and anticipation of potential threats of said environment:

an electronic enhanced three-dimensional environment awareness and piloting assistance computer; and

an obstruction database configured to provide the electronic environment awareness computer with data modelling a set of obstruction objects likely to be environmental threats for the aircraft; and

a primary flight display PFD, included in a synthetic vision system SVS or derivative, and configured to conformally display, in the terrain representation, a flight path vector symbol. The electronic enhanced three-dimensional environment awareness and piloting assistance computer, the obstruction database and the primary flight display are configured to execute a method for enhanced 3D awareness of the environment and anticipation of the potential threats of the environment as defined above.

According to particular embodiments, the system for enhanced three-dimensional awareness of the environment linked to the ground around an aircraft and anticipation of potential terrain threats comprises one or more of the following features, taken alone or in combination:

the electronic enhanced 3D environment awareness and piloting assistance computer is incorporated with and coupled to an automatic piloting subsystem so as to have a preferred emergency escape manoeuvre executed automatically by said automatic piloting subsystem, by providing the automatic piloting subsystem with a guiding target defined by a pair of parameters, characteristic of the target, formed by a first, slope parameter and a second, lateral trajectory parameter.

Another subject of the invention is a primary flight display PFD for displaying data on enhanced 3D awareness of the environment linked to the ground and aircraft piloting assistance data, the primary flight display being included in a synthetic vision system SVS or derivative, and configured to conformally display a flight path vector symbol. The primary flight display is configured to also display, as basic graphic item, a panoramic curve of safe minimum slope, as defined above, and additional graphic 3D awareness and/or piloting assistance information items, formed by: a first graphic item of colouring of the panoramic line of safe minimum slope, by a spectrum of colours, associated with the different avoidance manoeuvres corresponding to the azimuth directions of the field of view of the PFD and representative of the degrees of ease of execution of said avoidance manoeuvres; and/or

a second graphic item concerning surveillance information, notably the azimuth zone scanned, from a terrain surveillance and warning information system; and/or

a third graphic item, disposed on one side of the piloting screen of the PFD, designating a turn limit in the form of a bar and of a value indicating the maximum safe trajectory or track in case of the aircraft being incapable of executing a half-turn; and/or

a fourth graphic item concerning a range of hazardous or “prohibitive” roll angles; and/or

a fifth graphic item designating the relative direction corresponding to a maximum change of direction when the turn limit is outside of the field of view of the display screen; and/or

a sixth graphic display item designating a guiding target proposed to the pilot and displayed along the safe minimum slope line.

### BRIEF DESCRIPTION OF THE DRAWINGS

The invention will be better understood on reading the following description of several embodiments, given purely by way of example and with reference to the drawings in which:

FIG. 1 represents a view of the vertical component of a typical avoidance manoeuvre used to determine a panoramic curve of safe minimum slope according to the invention;

FIG. 2 represents a view of the component of the lateral manoeuvres for avoiding obstacles that are likely to become terrain threats around the aircraft and disposed around the aircraft;

FIG. 3 represents a view of an enhanced three-dimensional terrain awareness and piloting assistance system according to the invention;

FIG. 4 represents a flow diagram of an enhanced three-dimensional terrain awareness and piloting assistance method according to the invention;

FIG. 5 represents a view of a three-dimensional view display according to the invention, configured to conformally display, in a three-dimensional terrain environment, enhanced three-dimensional terrain awareness and piloting assistance information, generated by the avionics system and method of FIGS. 3 and 4.

### DETAILED DESCRIPTION

Generally, the concept of the invention is based on the possibility of anticipating terrain threats in their diversity and guarding against them fairly early, by increasing the awareness of the terrain environment of the aircraft and of the potential terrestrial threats, by widening the escape options by the use of a possible lateral component of the escape manoeuvres and by merging the surveillance information with other functions, piloting functions in particular, in a synthetic vision system or derivative.

The avionics system and the avionics method for enhanced awareness of the environment linked to the ground and of potential warnings according to the invention are also based on the use of synthetic vision systems SVS, enhanced vision systems EVS, combined vision systems CVS combining an SVS and EVS, and on the use of head-up display technologies, which make it possible to display conformal information on the view of real terrain. These vision systems usually present a flight path vector which indicates to the pilot where the aircraft currently is flying within the perspective of a vision of a real terrain or of a synthesized terrain or of an enhanced terrain through a symbology or set of symbols.

The term “environment linked to the ground” or, in short, “environment”, designates, here and hereinbelow, the terrain and/or the air space volumes that are prohibited because they can possibly be reached by projectiles launched from the ground, for example by anti-aircraft defence batteries.

The term “terrain” designates, here and hereinbelow and generally, the natural surface of the ground as represented by topographic data and any obstruction object which is situated on the natural topographic surface such as, for example, trees and/or artificial obstacles such as buildings, antennas and pylons.

The avionics system and the avionics method, for enhanced awareness of the three-dimensional environment linked to the ground around the aircraft and piloting assistance for anticipating, without overreactions, the potential threats of said environment, are based primarily on the calculation of the panoramic curve of safe minimum slope, established over a region of terrain of interest ROI (“Region Of Interest”) which extends around the aircraft according to a predetermined fixed radius R, corresponding to a predetermined duration of a straight-line flight of the aircraft at the current ground speed, and based on the conformal display of this panoramic curve on a primary navigation and piloting screen, using a synthetic 3D vision system and having a flight path vector represented conformally.

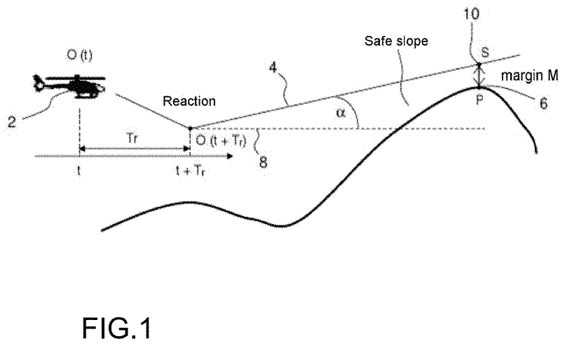

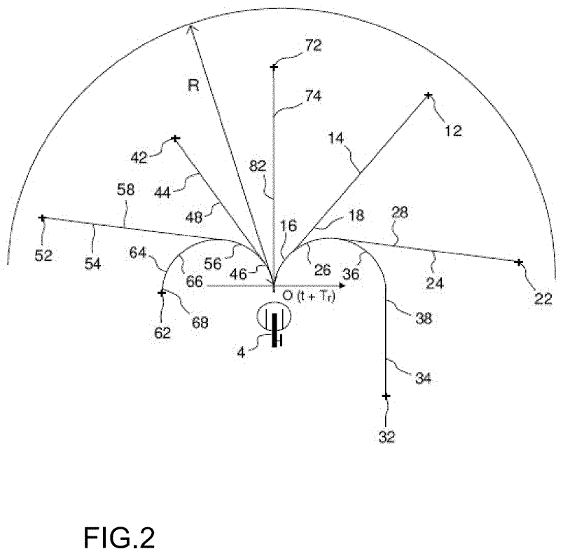

According to FIGS. 1 and 2, the calculation of the flat panoramic curve of safe minimum slope is based, for each azimuth direction of the aircraft, that can be represented along its azimuth axis with zero roll, and for each envelope point of an obstacle situated in said direction at a lateral distance less than or equal to the predetermined fixed radius R of the region of interest ROI, on a generic modelling of a trajectory of climb, of overflight and of lateral rejoining of said envelope point of the obstacle.

Each trajectory of climb, of overflight and of lateral rejoining of an associated obstacle envelope point is assumed to follow a reaction phase as described by way of example in FIG. 1.

According to FIG. 1, the aircraft 2, for example, here, a helicopter, is assumed, from a current instant t of measurement of the kinematic parameters of the aircraft 2, to continue its current flight for a first predetermined duration Tr, corresponding to the reaction time to effectively start the manoeuvre, assuming that a piloting command corresponding to this manoeuvre has been sent by the pilot, to a point O(t+Tr) of start of the trajectory 4 of climb, of overflight and of lateral rejoining associated with the envelope point P 6 of the obstacle, chosen by the pilot. It is noteworthy that the parameters concerning the reaction phase, and ultimately the determination of the reaction time, can be adapted to take account of the behaviour of other functions, such as the TAWS for example.

Here, in FIG. 1, the envelope point P 6 of the obstacle is the peak of a mountain. The safe slope, denoted α, is the slope relative to the terrestrial horizontal 8 of the vertical component of the trajectory 4 of climb, of overflight and of rejoining of the envelope point P at the point S, situated above the point P at the distance M corresponding to the terrain clearance margin or gap.

The calculation of the line of safe minimum slope is based on the definition of the “most natural” escape manoeuvre that the pilot will have to execute as a function of the azimuth direction chosen at the current instant, and which takes account of the degree of tightness of the turn, and the sequencing of the turn and the climb in a straight line, in order to enhance the intuitive nature of the performance.

The safe vertical trajectory is calculated for each terrain point or each obstacle present in the immediate vicinity of the aircraft by taking account of the required turn necessary to reach the point.

If reaching an obstacle point requires a turn to be performed partially, the climb performance in the turn is considered.

According to FIG. 2, a set 2 of obstacle envelope points and of the associated lateral rejoining and overflight trajectories is illustrated by way of example.

Here, the aircraft 4 is for example a helicopter which is at the actual instant t+Tr of performance of the manoeuvre at the point O(t+Tr).

A first obstacle envelope point 12 is associated with a first lateral rejoining trajectory 14 which is broken down into a first turn section 16 starting from the point O(t+Tr), which is followed by a second rectilinear section 18 which reaches the first obstacle envelope point 12.

A second obstacle envelope point 22 is associated with a second lateral rejoining trajectory 24 which is broken down into a first turn section 26 of second trajectory starting from the point O(t+Tr), which is followed by a second rectilinear section 28 of second trajectory which reaches the first obstacle envelope point 22.

A third obstacle envelope point 32 is associated with a third lateral rejoining trajectory 34 which is broken down into a first turn section 36 of third trajectory starting from the point O(t+Tr), which is followed by a second rectilinear section 38 of third trajectory which reaches the third obstacle envelope point 32.

A fourth obstacle envelope point 42 is associated with a fourth lateral rejoining trajectory 44 which is broken down into a first turn section 46 of fourth trajectory starting from the point O(t+Tr), which is followed by a second rectilinear section 48 of fourth trajectory which reaches the fourth obstacle envelope point 42.

A fifth obstacle envelope point 52 is associated with a fifth lateral rejoining trajectory 54 which is broken down into a first turn section 56 of fifth trajectory starting from the point O(t+Tr), which is followed by a second rectilinear section 58 of fifth trajectory which reaches the fifth obstacle envelope point 52.

A sixth obstacle envelope point 62 is associated with a sixth lateral rejoining trajectory 64 which is broken down into a first turn section 66 of sixth trajectory starting from the point O(t+Tr), which is followed by a second rectilinear section 68 of sixth trajectory which reaches the sixth obstacle envelope point 62.

A seventh obstacle envelope point 72 is associated with a seventh trajectory 74 which is limited to a rectilinear segment 78 starting from the point O(t+Tr) and going to the seventh obstacle envelope point 72.

The lateral direction of vision of a given obstacle envelope point is the angle formed between the direction of vision of the obstacle envelope point and the longitudinal horizonal direction 82 of the aircraft 4, the angle being oriented in the clockwise direction, i.e. positively from left to right in FIG. 1.

Thus, the direction of vision of the seventh obstacle envelope point 72 corresponds to an azimuth angle of the aircraft of zero value, the directions of vision of the first and second obstacle envelope points 12, 22 correspond to positive azimuth angles of the aircraft of first quadrant lying between 0 and +90 degrees, the direction of the third obstacle envelope point 32 corresponds to a positive azimuth angle of the aircraft of second quadrant lying between +90 and +180 degrees, the direction of vision of the sixth obstacle point 62 corresponds to a negative azimuth angle of the aircraft of third quadrant lying between −90 and −180 degrees, and the directions of vision of the fourth and fifth obstacle envelope points 42, 52 correspond to negative azimuth angles of the aircraft of fourth quadrant lying between 0 and −90 degrees.

Thus, the direction of vision of the seventh obstacle envelope point 72 corresponds to an azimuth angle of the aircraft of zero value, the directions of vision of the first and second obstacle envelope points 12, 22 correspond to positive azimuth angles of the aircraft of first quadrant lying between 0 and +90 degrees, the direction of the third obstacle envelope point 32 corresponds to a positive azimuth angle of the aircraft of second quadrant lying between +90 and +180 degrees, the direction of vision of the sixth obstacle point 62 corresponds to a negative azimuth angle of the aircraft of third quadrant lying between −90 and −180 degrees, and the directions of vision of the fourth and fifth obstacle envelope points 42, 52 correspond to negative azimuth angles of the aircraft of fourth quadrant lying between 0 and −90 degrees.

Note that other geometrical forms of the lateral rejoining and overflight trajectories, not necessarily limited to a turn or a straight segment or the sequencing of a turn and of a straight segment, can be envisaged.

The avionics method and the avionics system for enhanced 3D awareness of the terrain and anticipation of the terrain threats according to the invention are configured to provide relevant panoramic information on the environment of the aircraft all around the latter.

The avionic system and the avionic method according to the invention are configured to provide the pilot of the aircraft with more relevant information concerning the location of the potential environmental threats linked to the ground around the aircraft by widening the angular range of azimuth scanning. Thus, the awareness of the environment linked to the ground for the pilot is enhanced when the aircraft approaches the ground and the pilot is also assisted in creating, with an extended anticipation time, the best strategy for vertical and lateral avoidance of the potential threats of said environment.

The information provided to the pilot, by incorporating the current flight parameters and the current aircraft manoeuvring possibilities, i.e. the possibilities of climbing, the constraints on a switch back turn for the aircraft, allow the pilot to choose the best achievable escape manoeuvre.

A secondary feature of the avionics method and system according to the invention is their capacity to provide piloting assistance information to an automatic piloting system, operating possibly through learning, in the case of an automatic implementation of the terrain threats avoidance manoeuvres.

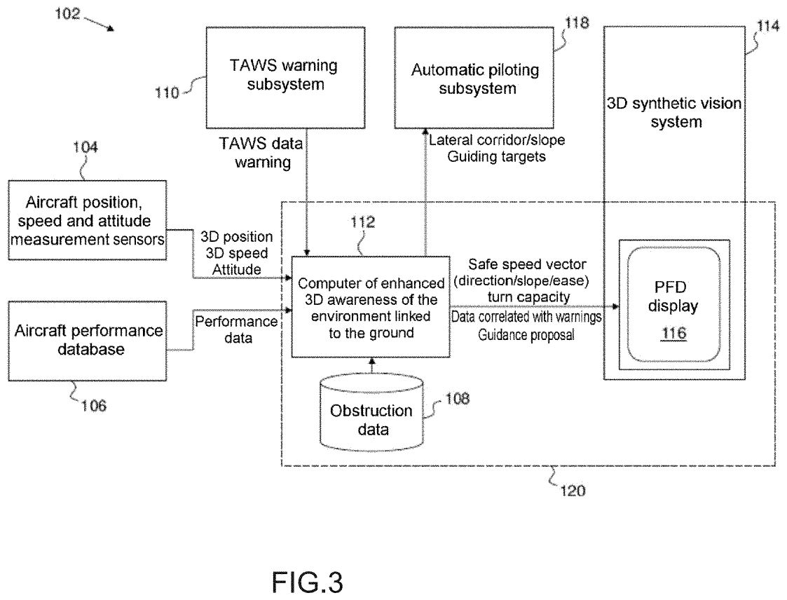

According to FIG. 3, a navigation and piloting avionics system 102 of an aircraft 4 with enhanced three-dimensional awareness of the environment linked to the ground comprises:

an embedded set of sensors 104 for measuring the position and the speed of the aircraft and the attitude of the aircraft 4;

a first database 106 of aircraft performance characteristics;

a second, obstruction database 108 containing obstruction objects notably modelled obstacles of the terrain around the aircraft;

a terrain warning subsystem 110;

a computer 112 for enhanced three-dimensional awareness of the environment linked to the ground surrounding the aircraft and anticipation of the potential threats of said environment through piloting assistance;

a synthetic vision system SVS or derivative 114, including a primary flight display PFD 116, configured to conformally display, in the representation of the terrain, a flight path vector; and

an optional automatic piloting subsystem 118.

The embedded set of the sensors 104 for measuring the position, the speed and the attitude of the aircraft is configured to measure, at each instant, in real time or virtually in real time, the kinematics and the attitude of the aircraft 4, and provide, at each instant to the computer for enhanced three-dimensional awareness of the environment and piloting assistance, data on three-dimensional positions and speeds of the centre of gravity of the aircraft and of attitudes of the aircraft.

The embedded set of the sensors 104 for measuring the kinematics and the attitude of the aircraft comprises for example:

a barometric altimeter, for example an ADC (Air Data Computer) device, or a global satellite navigation system GNSS (“Global Navigation Satellite System”) for measuring the altitude of the aircraft;

a global navigation satellite system GNSS, possibly hybridized with inertia data supplied by one or more inertial sensors to measure the horizontal positions of the aircraft and the tracking thereof;

an air speed sensor, for example an ADC sensor and/or a global navigation satellite system GNSS, and/or possibly an inertial system for measuring the horizontal and vertical speeds of the aircraft;

an attitude or inertial reference system AHRS/IRS (“Attitude and Heading Reference System”/“Inertial Reference System”) for measuring the attitudes of the aircraft.

The first, aircraft performance database 106 is configured to provide the computer 112 for enhanced three-dimensional awareness of the terrain and piloting assistance, with aircraft performance data, also designated as “performance or flight envelope” data, concerning the climb capability of the aircraft as a function notably of elevation, temperature, weight and horizontal speed.

The second, obstruction database 108 is configured to provide the computer 112 for enhanced three-dimensional awareness of the environment and piloting assistance, with data modelling a set of obstruction objects likely to be environmental threats for the aircraft.

The warning subsystem 108 is, for example, a conventional terrain awareness and warning system TAWS.

The computer 112 for enhanced awareness of the environment and piloting assistance with respect to temporal threats, the primary flight display 116, and the second, obstruction database 108 together form a system 120 for enhanced awareness of the environment and anticipation of the potential environmental threats.

The computer 112 for enhanced three-dimensional awareness of the environment and piloting assistance is a set of one or more computers.

The computer 112 for enhanced awareness of the terrain and anticipation of the potential threats is configured to assess escape options.

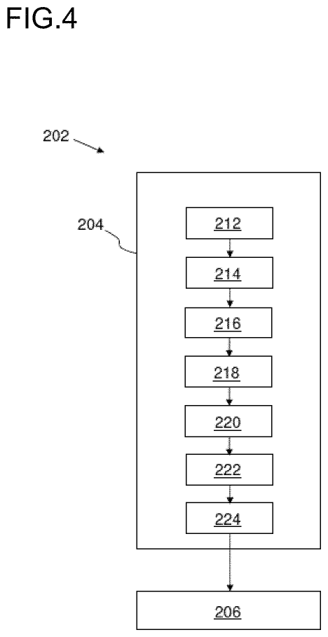

According to FIG. 4, a method 202 for enhanced 3D awareness of the environment linked to the ground and anticipation of the potential environmental threats, for calculating and displaying the line of safe minimum slope, implemented by the computer for enhanced three-dimensional awareness of the environment, comprises a set of steps, executed in succession.

The method for enhanced 3D awareness and the corresponding algorithm for implementation of said method are based on an analysis of a digital 3D model of the environment, notably the terrain and various obstacles which surround the aircraft, established from static data and/or dynamic detection. The analysis of this digital 3D model of the terrain environment makes it possible to calculate the vertical component of a flight trajectory with safe minimum slope, the following of which guarantees a minimum vertical clearance between the terrain and the aircraft, this minimum clearance being set by the safety margin M.

The method 202 for enhanced 3D awareness of the environment linked to the ground and anticipation of the potential environmental threats in the vicinity of the aircraft comprises a first step 204 of calculation of a panoramic curve of safe minimum slope as a function of the azimuth vision from the aircraft considered in a horizontal plane parallel to the plane of the ground and containing the centre of gravity G of the aircraft, and then a second step 206 of display of the panoramic curve of safe minimum slope and of supporting information items is executed when the display receives a command to display graphic items concerning the enhanced 3D awareness of the environment around the aircraft and piloting assistance with respect to identified potential threats of the environment.

The first step 204 comprises a set of substeps 212, 214, 216, 218, 220, 222 and 224.

In a first substep 212, at a current instant t, the position of a reference point O(t+Tr) and of a possible start of avoidance manoeuvre is calculated by following the current trajectory of the aircraft starting from the current position O(t) of the aircraft at the instant t for a predetermined duration Tr which corresponds to a reaction or response time, typically lying between 0 and 2 seconds.

Then, in a second substep 214, for each obstruction object of a set OB1(t) of obstruction objects, situated within a predetermined radius R in the lateral or horizontal vicinity of the aircraft relative to the point O(t+Tr) and outside of the lateral vicinity of the aircraft relative to the point O(t) within a reaction radius Rr, equal to the lateral distance between the points O(t) and O(t+Tr), with R significantly greater than Rr, a horizontal path or lateral flight component to reach the envelope of the obstruction object of the set OB1(t) of obstruction objects is calculated, by considering a lateral path composed of a turn with a rate of turn standardized as a function of the type of the aircraft (helicopter or aeroplane, civil or military for example) and of the manoeuvring capabilities of the aircraft, and/or of a successive rectilinear segment from the exit from the turn to the obstruction object. The obstruction objects of this set OB1(t) processed in this second substep 214 are provided by the second database 108 of obstruction objects. Generally, the obstruction objects are modelled as a function of the nature of the obstruction with which they are likely to confront the aircraft, the nature of the obstruction object being contained in the set of the terrain obstacles modelled by terrain cells, artificial objects, such as, for example, a building or a set of buildings, modelled by volumes, and prohibited air spaces modelled by straight cylinders.

Then, in a third substep 216, for each obstruction object of the set OB1(t), a margin M is added to the elevation of the envelope point of said obstruction object and the slope between the point O(t+Tr) reached by following, after the current instant t, the trajectory of the aircraft for the predetermined duration Tr of reaction time and the point of overflight at the safe avoidance distance M from the envelope point of the obstruction object is calculated by considering the horizontal trajectory determined in the first step.

Then, in a fourth substep 218, the obstruction objects of the set OB1(t) are grouped together by azimuth direction of visibility from the aircraft in segments or sweeps of azimuth directions of the same width or angular resolution pitch n, the angular resolution pitch n being expressed for example in degrees.

In a consecutive fifth substep 220, for each sweep of azimuth directions scanning an azimuth field of view of the aircraft, the maximum of the safe minimum slopes of the obstruction objects contained in said sweep of azimuth directions is determined by the computer for enhanced 3D awareness of the terrain surrounding the aircraft. Thus, each sweep of azimuth directions has an associated point whose abscissa is the mean azimuth angle of the sweep along the current horizontal azimuth axis of the aircraft and the ordinate is the maximum value of the safe minimum slopes of the obstruction objects contained within the sweep, said maximum value being called “safe minimum slope of said sweep of azimuth directions”. The curve regularly interpolating the points calculated in the fifth substep 220, associated respectively with the sweeps of azimuth directions scanning the azimuth field of view of the aircraft is called “panoramic curve of safe minimum slope” as a function of the azimuth direction, considered in the current horizontal plane of the aircraft.

Preferably, the azimuth field of view of the aircraft scanned by the sweeps is greater than the azimuth field of a conventional terrain awareness and warning subsystem such as, for example, the TAWS, and, even more preferably, significantly greater, that is to say at least two times greater.

Then, in a sixth substep 222, for each azimuth direction, the position of the associated point of the panoramic curve of safe minimum slope is compared to the maximum slope that can effectively be achieved by the aircraft as set by the performance envelope of the aircraft. For each azimuth direction considered, the ratio of the ordinate of the associated point of the panoramic curve of safe minimum slope, i.e. the safe minimum slope, to the maximum slope that can be achieved by the aircraft is calculated then coded by a colour code or line pattern, representative of a level of ease with which the obstruction obstacle can safely be overflown. When the safe minimum slope is significantly below the maximum slope that can be achieved by the aircraft, this safe minimum slope is considered as easy to achieve and the level of ease is high, whereas, when the safe minimum slope is significantly above the maximum slope that can be achieved by the aircraft, this safe minimum slope is considered to be impossible to achieve and the level of ease is zero.

Then, in a seventh substep 224, a condition or a criterion for display of the panoramic line of safe minimum slope is calculated by comparing the position of the panoramic curve of safe minimum slope to the position of the current flight path vector. If there is an azimuth direction for which the position difference between the flight path vector and the associated point of the panoramic curve of safe minimum slope becomes too low, the ordinate in terms of pitch of the flight path vector minus the safe minimum slope of the corresponding point of the panoramic curve is less than or equal to a predetermined positive threshold value, a command to display the panoramic curve of safe minimum slope and any supporting information items is sent.

As a variant, a command to display the panoramic curve of safe minimum slope and any supporting information items can be sent arbitrarily by the pilot.

Then, when a display command is received by the primary flight display, the second, display step 206 is implemented.

During the second, display step 206, the primary flight display PFD displays, by merging them conformally, the panoramic curve of safe minimum slope and, in support, a first graphic information item and/or a second graphic information item and/or, in support, a third graphic information item and/or, in support, a fourth graphic information item.

The display of the panoramic curve of safe minimum slope takes place conformally in the wide field of view of the primary flight display.

The first graphic item concerns the display for each sweep of azimuth direction of the calculated and coded ratio of the safe minimum slope to the maximum slope of climb that can be achieved by the aircraft, in a form, for example, of a corresponding colour according to the coding chosen. For example, the coding is chosen so as to follow the progression of the colours of the rainbow, by displaying the colour green when the safe minimum slope is very far by lower values from the maximum achievable slope, and progressing to the colour magenta when the safe minimum slope is above, i.e. exceeds by higher values, the maximum achievable slope. It is recalled that no panoramic curve of safe minimum slope is displayed as long as a display command has not been sent to the primary flight display.

The second graphic information item concerns the capacity to find a safe slope outside of the field of view of the primary flight display for azimuth directions which cannot be displayed in the field of view of the display. The second graphic item is formed by a bar, displayed on one side of the PFD screen, which indicates the maximum possible turn with a safe turn attitude at the current speed. This bar indicates what maximum change of track or of horizontal corridor can be achieved.

The third graphic information item concerns a graphic item indicating the minimum roll angle necessary to perform a safe lateral escape. In the case of a triggered warning, the “prohibited” roll angles are displayed on a roll scale so that the pilot understands the minimum attitude to be achieved to recover or restore a safe situation.

The fourth graphic information item concerns surveillance information correlated with the TAWS system or other warning systems. In order to simplify the interpretation of the warnings associated with the obstacles, the fourth graphic item is displayed on or in immediate proximity to the panoramic curve of safe minimum slope so as to reveal the zone of operation of the TAWS warning system or of the other warning systems, for example by increasing the line thickness of the panoramic curve of safe minimum slope in said zone of the warning system or systems. This fourth graphic item assists the pilot in correlating the warnings with the enhanced 3D awareness of the terrain environment merged in the 3D image of the external environment of the aircraft, real or synthesized.

Optionally, an automatic piloting subsystem like that described for example in the U.S. Pat. No. 9,978,286 B2, can be incorporated in the system according to the invention for enhanced 3D awareness of the terrain and piloting assistance as described in FIGS. 1 to 4, so as to automatically execute a preferred emergency escape manoeuvre, in the case where the pilot does not react in time to the warnings triggered.

In this case, the guiding target, provided to the automatic piloting subsystem, is defined by a pair of parameters characteristic of the target, a first slope parameter and a first trajectory parameter. These parameters are calculated by analysing the line of safe minimum slope in all the directions to decide what trajectory and slope ought to be followed to minimize the probability of collision, even in the case where no satisfactory and safe trajectory has been found according to the assumptions made for the calculation of the minimum slope line. For that, it is considered that the “least bad” trajectory will provide the pilot with the best conditions to adapt his or her avoidance manoeuvre, even after an automatic avoidance has commenced.

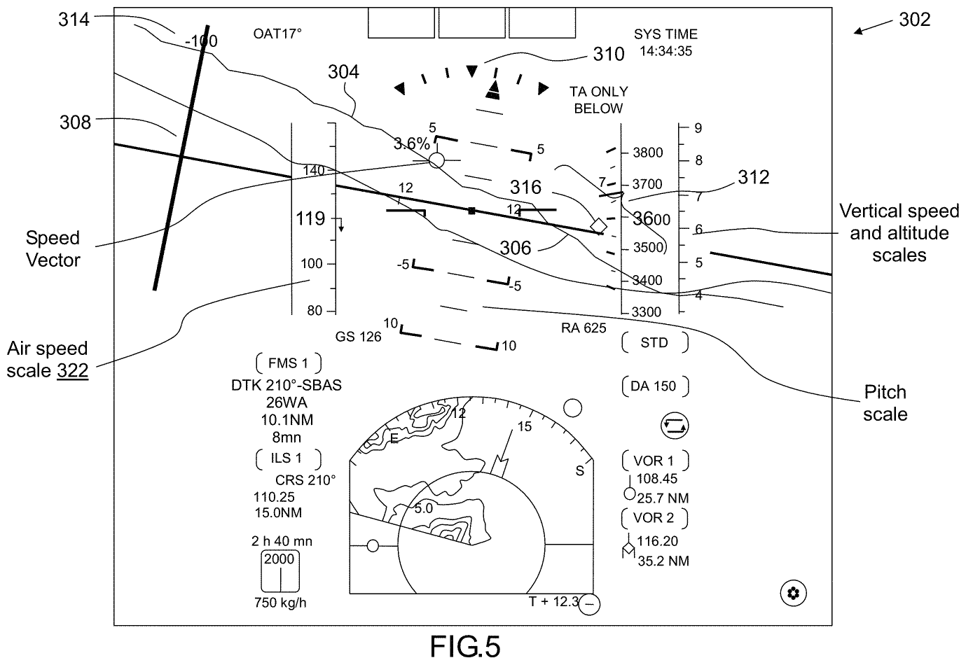

As illustrated in FIG. 5, the PFD display of the system for enhanced 3D awareness of the environment linked to the ground and anticipation of the environmental threats is configured to superpose the relevant information of said system for enhanced 3D awareness of the terrain and anticipation of the terrain threats, notably the panoramic curve of safe minimum slope with the piloting information, displayed conventionally conformally on the central field of view of the PFD and notably including the flight path vector symbol.

The preferred method for including the manoeuvring possibilities in the displayed information is to use an intuitive set of different colours to display a graphic item. The set of colours is chosen so as to correspond to the set of colours already used conventionally for the other, normal warning awareness information, varying from the colour green to designate manoeuvres that are easy to execute to the colour magenta to designate manoeuvres that are difficult to execute, if not critical.

The display according to the invention is configured to incorporate avoidance replicas in the piloting screen or primary flight display in a way that is consistent with the primary flight parameters, by superposing said replicas with the synthetic vision system, even the combined vision system or the head-up screen or any display showing a flight path vector.

According to FIG. 5 and a preferred embodiment of the display, the PFD display 302 according to the invention is configured to display as basic graphic item the panoramic curve 304 of safe minimum slope and additional graphic 3D awareness and/or piloting assistance information items.

A first graphic item 306 designates the panoramic line of safe minimum slope, coloured by a spectrum of colours, associated with the different avoidance manoeuvres corresponding to the azimuth directions of the field of view of the PFD and representative of the degrees of ease of execution of said avoidance manoeuvres.

A second graphic item 308, here disposed to the left on the piloting screen of the PFD, designates a turn limit. The preferred method for displaying a safe trajectory situated outside of the field of view of the primary flight display is to display a bar and a value indicating the maximum safe trajectory or track in case of the aircraft being incapable of executing a half-turn.

A third graphic item 312 designates a range of hazardous or “prohibited” roll angles. In case of a threat facing the aircraft, the inclination angles which would lead to a collision because of an inadequate safety margin are presented to the pilot with a logic or a colour coding similar to that used by the collision avoidance systems TCAS (“Traffic Collision Avoidance System”) on the vertical speed scale to describe the no-fly domains.

A fourth graphic item 312 concerns surveillance information such as, for example, the zone scanned by the TAWS information system, which allows the pilot to more accurately understand the context of triggering warnings.

A fifth graphic item 314 designates the relative direction corresponding to a maximum change of direction when the turn limit is outside of the field of view of the display screen.

A sixth graphic display item 316 designates the guiding target proposed to the pilot and displayed along the line of safe minimum slope.

This display allows the pilot to have an immediate read of the current threats and to choose the most appropriate escape manoeuvre, by also taking into account the manoeuvrability capabilities of the aircraft.

The proposed solution provides short-term information, suited to short-term piloting decisions: the scanned area covers only a few seconds of flight beyond the current position of the aircraft, suitable for an immediate escape and without regard to medium and long-term trajectories.

These items minimize the risk of overreaction by providing the minimum manoeuvre to be executed to fly safely and avoid the terrestrial threats.

The proposed solution includes methods which anticipate threats and which provide, in time, information in advance to assist the pilot in avoiding the warning situations without overloading the display if no threat has occurred.

The proposed solution includes the merging of the minimum safe trajectory information with added information concerning the associated warning system, in order to assist the pilot in correlating the information coming from the different awareness and warning functions.

The solution includes the calculation and the display of the minimum roll angle to be performed to avoid a collision with an approaching threat on the flight trajectory currently being followed.

By merging information concerning the terrestrial environment with piloting information, the invention makes it much easier to manage critical situations, including in conditions of control of an unmanned aircraft.

1. A method for enhanced three-dimensional awareness of the environment linked to the ground around an aircraft and anticipation of the potential threats of said environment;
the method for enhanced 3D awareness of the environment and anticipation of the potential environmental threats being implemented by a system for enhanced 3D awareness of the environment around the aircraft and of potential environmental threats comprising:
an electronic enhanced three-dimensional environment awareness and piloting assistance computer; and
an obstruction database configured to provide the electronic environment awareness computer with data modelling a set of obstruction objects likely to be environmental threats for the aircraft; and
a primary flight display PFD, included in a synthetic vision system SVS or derivative, and configured to conformally display, in the terrain representation, a flight path vector symbol;
the method for enhanced three-dimensional awareness of the environment and anticipation of potential environmental threats comprising:
a first step of calculation of a panoramic curve representing the trend of a safe minimum slope for crossing obstacles as a function of the azimuth angle of the aircraft in its local horizontal plane of lateral movement; and
a second step, consecutive and executed on command, of display of the panoramic curve of safe minimum slope and of any piloting assistance information.

2. The method for enhanced 3D awareness of the environment linked to the ground and anticipation of the potential threats of said environment according to claim 1, wherein the first, calculation step comprises:
a first substep during which, at a current instant t, the position of a reference point O(t+Tr) and of a possible start t+Tr of avoidance manoeuvre is calculated by following the current trajectory of the aircraft starting from the current position O(t) of the aircraft at the instant t for a predetermined duration Tr which corresponds to a reaction or response time;
a second consecutive substep during which, for each obstruction object of a set OB1(t) of obstruction objects, situated within a predetermined radius R in the lateral or horizontal vicinity of the aircraft relative to the point O(t+Tr) and outside of the lateral vicinity of the aircraft relative to the point O(t) within a reaction radius Rr, equal to the lateral distance between the points O(t) and O(t+Tr), with R significantly greater than Rr, a horizontal path or lateral flight component to reach the envelope of the obstruction object of the set OB1(t) of obstruction objects is calculated.

3. The method for enhanced 3D awareness of the environment linked to the ground and anticipation of the potential threats of said environment according to claim 2, wherein
the predetermined duration Tr which corresponds to a reaction or response time typically lies between 0 and 2 seconds; and/or
each lateral path is composed of a turn with a rate of turn standardized as a function of the type of the aircraft and of the manoeuvring capabilities of the aircraft, and/or of a successive rectilinear segment from the exit from the turn to the obstruction object.

4. The method for enhanced 3D awareness of the environment linked to the ground and anticipation of the potential threats from the environment according to claim 1, wherein
the environmental threats linked to the ground for the aircraft concern the terrain threats including the geographic terrain and artificial obstacles and concern air space volumes that are prohibited because they can possibly be reached by projectiles launched from the ground.

5. The method for enhanced 3D awareness of the environment linked to the ground and anticipation of the potential terrain threats according to claim 2, wherein
the obstruction objects of the set OB1(t), processed in the second substep, are supplied by a second database of obstruction objects.

6. The method for enhanced 3D awareness of the environment linked to the ground and anticipation of the potential threats of said environment according to claim 2, wherein the first, calculation step comprises:
a third substep during which, for each obstruction object of the set OB1(t), a margin M is added to the elevation of the envelope point of said obstruction object and the slope between the point O(t+Tr) reached by following, after the current instant t, the trajectory of the aircraft for the predetermined duration Tr of reaction time and the point of overflight at the safe avoidance distance M from the envelope point of the obstruction object is calculated by considering the horizontal trajectory determined in the second substep.

7. The method for enhanced 3D awareness of the environment linked to the ground and anticipation of the potential threats of said environment according to claim 6, wherein the first, calculation step comprises:
a fourth substep, executed after the third substep and during which the obstruction objects of the set OB1(t) are grouped together by azimuth direction of visibility from the aircraft in segments or sweeps of azimuth directions of the same width or angular resolution pitch n, the angular resolution pitch n being expressed for example in degrees.

8. The method for enhanced 3D awareness of the environment linked to the ground and anticipation of the potential threats of said environment according to claim 7, wherein the first, calculation step comprises:
a fifth substep, executed after the fourth substep and during which, for each sweep of azimuth directions scanning an azimuth field of view of the aircraft, the maximum of the safe minimum slopes of the obstruction objects contained in said sweep of azimuth directions is determined by the computer for enhanced 3D awareness of the terrain surrounding the aircraft, such that each sweep of azimuth directions has an associated point whose abscissa is the mean azimuth angle of the sweep along the current horizontal azimuth axis of the aircraft and the ordinate is the maximum value of the safe minimum slopes of the obstruction objects contained within the sweep, said maximum value being called “safe minimum slope of said sweep of azimuth directions”.

9. The method for enhanced 3D awareness of the environment linked to the ground and anticipation of the potential threats of said environment according to claim 8, wherein
the panoramic curve of safe minimum slope which is a function of the azimuth direction, considered in the current horizontal plane of the aircraft, is a curve regularly interpolating the points calculated in the fifth substep, associated respectively with the sweeps of azimuth directions scanning the azimuth field of view of the aircraft.

10. The method for enhanced 3D awareness of the environment linked to the ground and anticipation of the potential threats of said environment according to claim 9, wherein
the azimuth field of view of the aircraft scanned by the sweeps of azimuth directions is greater than the azimuth field of a conventional terrain awareness and warning subsystem, notably a system of TAWS type, preferably significantly greater, that is to say at least two times greater.

11. The method for enhanced 3D awareness of the environment linked to the ground and anticipation of the potential threats of said environment according to claim 1, wherein the first, calculation step comprises a sixth substep wherein:
for each azimuth direction, the position of the associated point of the panoramic curve of safe minimum slope is compared to the maximum slope that can effectively be achieved by the aircraft as set by the performance envelope of the aircraft; and
for each azimuth direction considered, the ratio of the ordinate of the associated point of the panoramic curve of safe minimum slope, i.e. the safe minimum slope, to the maximum slope that can be achieved by the aircraft is calculated then coded by a colour code or line pattern, representative of a level of ease with which the obstruction obstacle can safely be overflown.

12. The method for enhanced 3D awareness of the environment linked to the ground and anticipation of the potential threats of said environment according to claim 11, wherein the first, calculation step comprises
a seventh substep, executed after the sixth substep, and wherein a condition or a criterion for display of the panoramic safe slope line is calculated by comparing the position of the panoramic curve of safe minimum slope to the position of the current flight path vector; and, if there is an azimuth direction for which the position difference between the flight path vector and the associated point of the panoramic curve of safe minimum slope becomes too low, that is to say if the ordinate in terms of pitch of the flight path vector minus the safe minimum slope of the corresponding point of the panoramic curve is less than or equal to a predetermined positive threshold value, a command to display the panoramic curve of safe minimum slope and any supporting information items is sent.

13. The method for enhanced 3D awareness of the environment linked to the ground and anticipation of the potential threats of said environment according to claim 1, wherein
the second, display step is implemented when a display command is received by the primary flight display; and
during the second, display step, the primary flight display PFD displays, by merging them conformally, the panoramic curve of safe minimum slope and, in support, a first graphic information item and/or a second graphic information item and/or, in support, a third graphic information item and/or, in support, a fourth graphic information item.

14. The method for enhanced 3D awareness of the environment linked to the ground and anticipation of the potential threats of said environment according to claim 13, wherein
the display of the panoramic curve of safe minimum slope takes place conformally in the wide field of view of the primary flight display; and/or
the first graphic item concerns the display for each sweep of azimuth direction of a calculated and coded ratio of the safe minimum slope to the maximum slope of climb that can be achieved by the aircraft, in the form of a colour or a corresponding line pattern according to a chosen coding of the calculated ratio; and/or
the second graphic information item concerns the capacity to find a safe slope outside of the field of view of the primary flight display for azimuth directions which cannot be displayed in the field of view of the display; and it is formed by a bar, displayed on one side of the PFD screen, indicating the maximum possible turn with a safe turn attitude at the current speed; and/or
the third graphic information item concerns a graphic item indicating the minimum roll angle necessary to perform a safe lateral exit, and, in case a warning is triggered, indicates the “prohibited” roll angles on a roll scale; and/or
the fourth graphic information item concerns surveillance information correlated with the TAWS system or other warning systems, and it is displayed on or in immediate proximity to the panoramic curve of safe minimum slope so as to reveal the zone of operation of the TAWS warning system or of the other warning systems, by increasing the line thickness of the panoramic curve of safe minimum slope in said zone of the warning system or systems.

15. A system for enhanced three-dimensional awareness of the environment linked to the ground around an aircraft and anticipation of the potential threats of said environment comprising:
an electronic enhanced three-dimensional environment awareness and piloting assistance computer; and
an obstruction database configured to provide the electronic environment awareness computer with data modelling a set of obstruction objects likely to be environmental threats for the aircraft; and
a primary flight display PFD, included in a synthetic vision system SVS or derivative, and configured to conformally display, in the terrain representation, a flight path vector symbol;
the electronic enhanced three-dimensional environment awareness and piloting assistance computer, the obstruction database, and the primary flight display being configured to execute a method for enhanced 3D awareness of the environment and anticipation of the potential threats of the environment, defined according to claim 1.

16. The system for enhanced three-dimensional awareness of the environment linked to the ground around an aircraft and anticipation of the potential threats of said environment according to claim 15, wherein
the electronic enhanced environment 3D environment awareness and piloting assistance computer is incorporated with and coupled to an automatic piloting subsystem so as to have a preferred emergency escape manoeuvre executed automatically by said automatic piloting subsystem, by providing the automatic piloting subsystem with a guiding target defined by a pair of parameters,
characteristic of the target, formed by a first, slope parameter and a second, lateral trajectory parameter.

17. A primary flight display PFD for displaying data for enhanced 3D awareness of the environment linked to the ground and aircraft piloting assistance data,
the primary flight display being included in a synthetic vision system SVS or derivative, and configured to conformally display a flight path vector symbol; and
the primary flight display being configured to also display, as basic graphic item, a panoramic curve of safe minimum slope, defined according to claim 1, and additional graphic 3D awareness and/or piloting assistance information items, formed by:
a first graphic item of colouring of the panoramic line of safe minimum slope, by a spectrum of colours, associated with different avoidance manoeuvres corresponding to the azimuth directions of the field of view of the PFD and representative of the degrees of ease of execution of said avoidance manoeuvres; and/or
a second graphic item concerning surveillance information, notably the azimuth zone scanned, from a terrain surveillance and warning information system; and/or
a third graphic item, disposed on one side of the piloting screen of the PFD, designating a turn limit in the form of a bar and of a value indicating the maximum safe trajectory or track in case of the aircraft being incapable of executing a half-turn; and/or
a fourth graphic item concerning a range of hazardous or “prohibited” roll angles; and/or
a fifth graphic item designating the relative direction corresponding to a maximum change of direction when the turn limit is outside of the field of view of the display screen; and/or
a sixth graphic display item designating a guiding target proposed to the pilot and displayed along the curve of safe minimum slope.
